(19) United States
(12) Patent Application Publication
(10) Pub. No.: US 2004/0108604 A1
(43) Pub. Date: Jun. 10, 2004

(54) Water level control device for a humidifier

(76) Inventors: Huang Chuan Pan, Tainan City (TW); Huang Chen Lung, Tainan City (TW)

Correspondence Address: Huang Chuan Pan, P.O. BOX 2-10, TAINAN CITY, TW

(21) Appl. No.: 10/176,840

(22) Filed: Jun. 18, 2002

Related U.S. Application Data
(63) Continuation-in-part of application No. 09/604,710, filed on Jun. 21, 2000, now abandoned.

(51) Int. Cl. F02M 37/00; B01D 47/00

(52) U.S. Cl. 261/26

(57) ABSTRACT

A water level control device for a humidifier includes a housing, a control electric circuit in the housing, and a mist produce, a water tank, a mist chamber on the water tank, a water level detector and a float in the water tank. The float has a magnet inside, and the water level detector has a Hall Effect Digital switch, which has two faces to activate with the magnet of the float when the float rises or descends together with the water level in the water tank. Then the Hall switch is turned on or off to inform the water level high or low, protecting the humidifier from damage caused in case of no water in the water tank.

This invention is continued-in-part of Ser. No. 09/604,710 and the Ser. No. 09/604,710 has been abandoned, this invention relates to a water level control device for a humidifier, particularly to one sensing the water level to cut off power so as to prevent a humidifier from damage by continual operation even in case of no water therein.

### BACKGROUND OF THE INVENTION

A known conventional humidifier shown in FIG. 1 has a needle detector A extending in a water tank to sense the water level in the water tank. Or another conventional humidifier shown in FIG. 2 has a float B and a switch near the float B to detect the water level so as to drive a mist producer (an ultrasonic oscillator or an electric heating tube) to control a control electric circuit to prevent a humidifier from burning by continual operation in case of no water left.

The needle detector is connected to a resistor connected in series with a base of a transistor and then extended in the water tank of a humidifier, as disclosed in a U.S. Pat. No. 4,820,453, wherein the needle detector extends in a tater tank can cut off power of a mist producer to protect a humidifier from continual operation in case of no water left in the water tank, by transmitting a signal to a control electric circuit when the needle detector does not contact water in the water tank owing to the water level lowering to under a safety level.

If the needle detector is practically provided in a water tank and a mist producer, the mist chamber may be full of mist water vapor to attach on the end of the needle detector. And even a micro volume of water vapor may activate the needle detector to produce very feeble signal to power a subsequent control electric circuit to half open, causing the mist producer burn owing to high temperature produced or melt a plastic housing.

U.S. Pat. No. 5,156,048 is a kind of fluid level detector, and honorable commissioner clearly mentioned in the office action and in the appended case'048.

In the above-mentioned '048 case, a sleeve 16 is provided in the water tank 10, and a connector 66 is provided in the sleeve 16. A Hall effect switch 62 or 64 is respectively provided on and under the circuit board 60, producing interaction respectively with a pair of magnet 50, which is contained in two compartments 44 and 46 of the float assembly 30 rising up or falling down together with the water level in the water tank 10.

However, combination of the float assembly 30 with the sleeve 16 is effected by fitting with each other, as shown in FIG. 5 of the '048 case, having the following disadvantages.

(1) As the pairs of magnets 50, which have a north pole and a south pole, the two Hall effect switches 62, 64 are necessary to be located respectively on the north poles magnet and on the south poles magnet so that the whole wiring system for the two Hall effect switches may cost much,

As the float assembly 30 is fitted together with the sleeve 16, it is doubtful that the float assembly may move up and down accurately with the water level or not.

Although the Hall effect digital switch is used as a fluid digital detector in the '048 case, it is only used to function as a common fluid level detector, different from the one in our case.

Applicant makes use of the Hall effect digital switch to function to detect the water level in the water tank 11 of a humidifier, and the water level detecting method of our case and the method of the conventional humidifier using a water level detector are mentioned in the Background of the invention in our case. In comparing our case and the conventional humidifier, it may be understood that our case really has technological improvement, safety, and practicability, equal to a structural breakthrough.

### SUMMARY OF THE INVENTION

This invention has been devised by the same applicant of the U.S. Pat. No. 4,820,453, including a Hall Effect Digital switch and a float provided with a magnet inside. Then the magnet cooperates with the Hall Effect Digital switch fixed in the housing, to detect the water level with no erroneous operation.

### BRIEF DESCRPTION OF DRAWING

This invention will be better understood by referring to the accompanying drawing, wherein:

FIG. 1 is a perspective view of a first known conventional humidifier;

FIG. 2 is a perspective view of a second known conventional humidifier;

FIG. 3 is a perspective view of a humidifier provided in a water level control device in the present invention;

FIG. 4 is a cross-sectional view of a first embodiment of a water level control device in the present invention;

FIG. 5 is a partial exploded perspective view of a water level control device for a humidifier in the present invention;

FIG. 6 is a cross-sectional view of a second embodiment of a water level control device in the present invention;

FIG. 7 is a diagram of a first embodiment of a control electric circuit for driving a Hall Effect Digital switch in the present invention; and,

FIG. 8 is a diagram of a second embodiment of a control electric circuit for driving a Hall Effect Digital switch in the present invention.

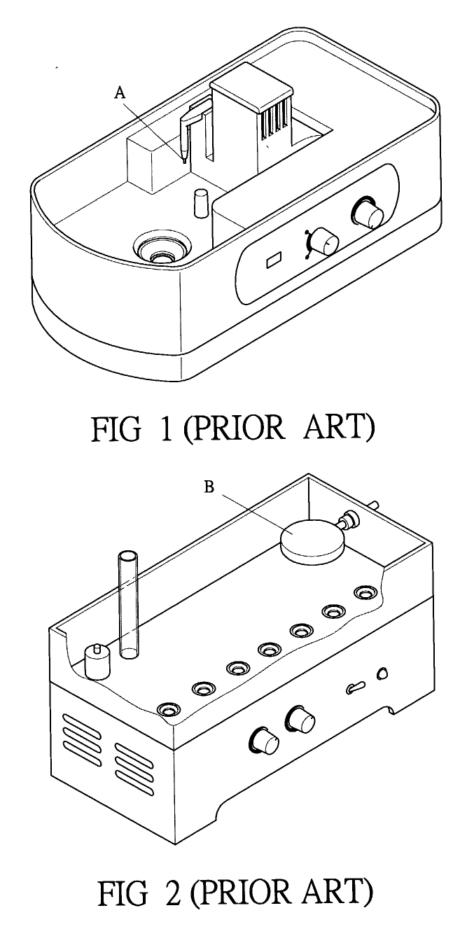

### DESCRIPTION OF THE INVENTION

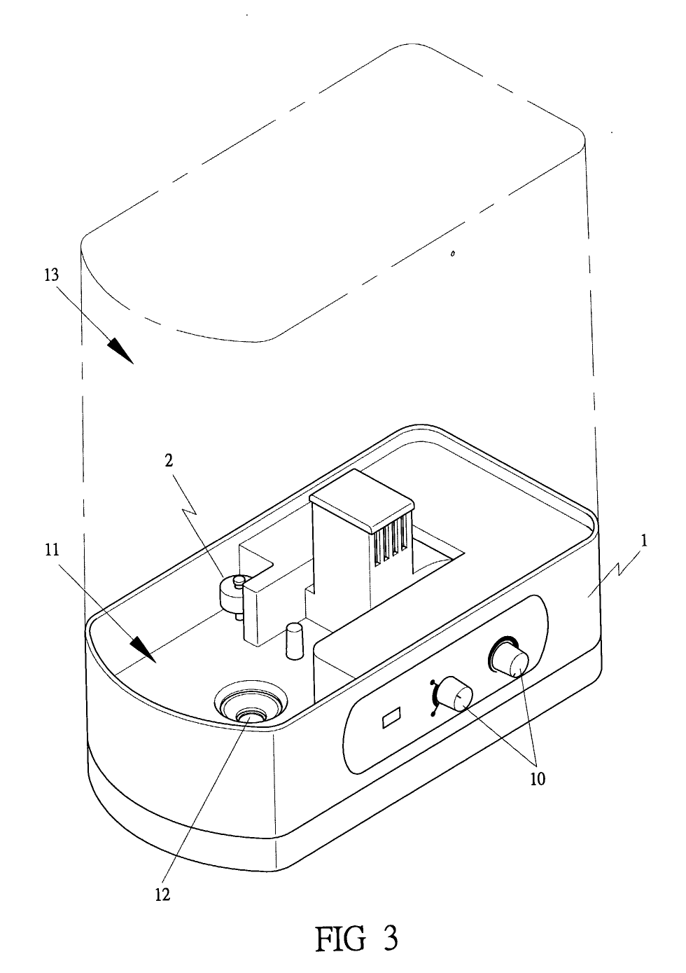

A first embodiment of a water level control device for a humidifier in the present invention, as shown in FIG. 3, includes a housing 1, a control electric circuit (not shown in FIG. 3) started or operating at a set time by means of a Hall Effect Digital switch 10, a water tank 11 placed on the housing 1 and provided with a mist producer 12 (an ultrasonic oscillator or an electric heating tube) and a mist chamber 13 placed on the water tank for temporarily storing vapor before flowing out of an outlet into a room.

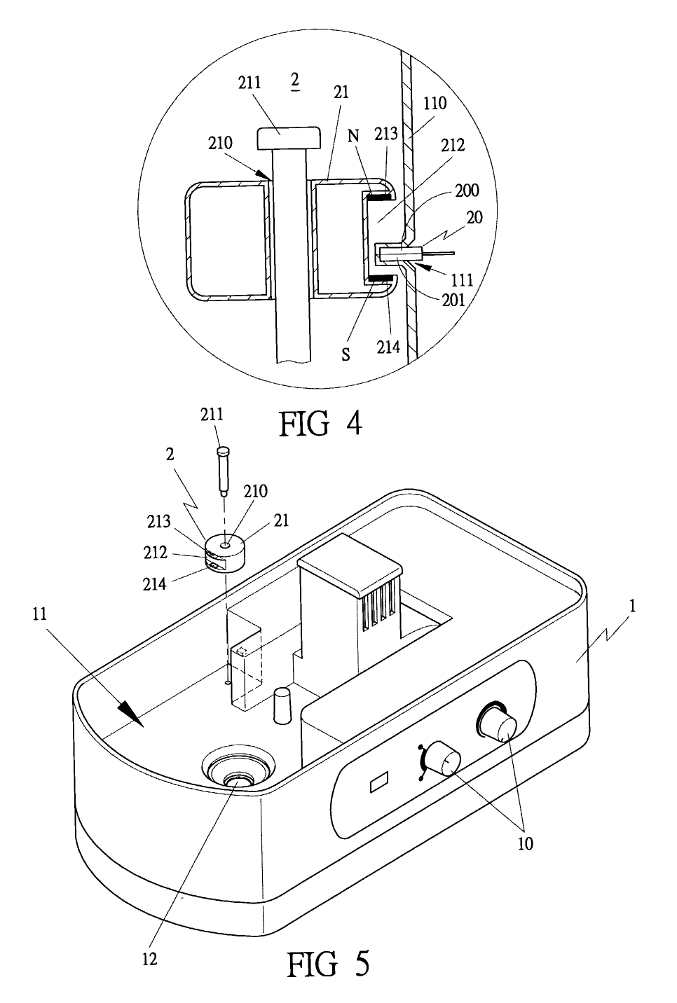

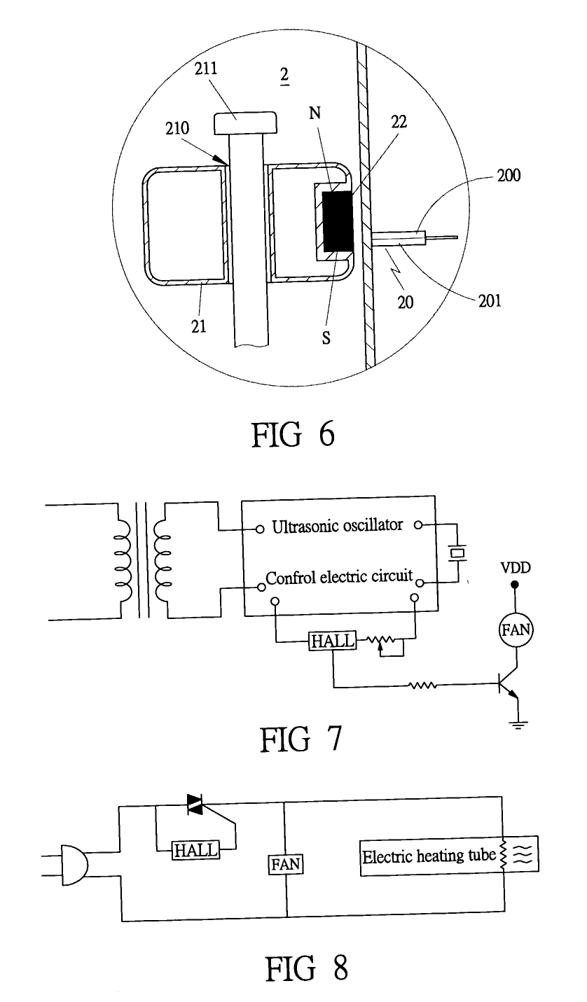

A water level detector 2 is provided in the water tank 11, consisting of a Hall Effect Digital Switch 20 having two separated faces 200, 201, which function to activate the switch 20 to turn on power to drive the water level detector 2 when a magnet or the like comes near them. The Hall effect digital switch 20 is positioned in an inner wall of the water tank 1, secured in a groove 111 provided in the inner wall 110 of the water tank 1, as shown in FIGS. 4, 5. Or the Hall effect digital switch 20 is secured closely on the inner wall 110, as shown in FIG. 6. Further, a float 21 is provided, having a center hole 210 for a float rod 211 vertically fitting in therein and limited in rising and descending, and a recess 212 formed in side, of float 21 and two magnets 213, 214 respectively fixed on an inner upper slot 215 an inner lower slot 216 of the recess 212, as shown in FIGS. 4, 5. When the float is move up or down the upper magnet 213 or the lower magnet 214 may move nearer to the two faces 200, 201 of the Hall Effect Digital switch 20 to turn it on. In case the magnet 213 moves nearer to the face 200 to turn on or off, it shows that the water lever descends to the lowest level. But incase the magnet 214 moves nearer to the face 201, turning on or off the Hall switch 20, showing the water level being the highest.

A second embodiment of a water level detector 2 is shown in FIG. 6, having a large magnet 22 instead of the two small magnets 213, 214 of the first embodiment fitted in the recess 212, The large magnet 22 has one north pole surface and another south pole surface to face two surfaces of the Hall switch 20 so as to produce interaction to drive the Hall switch 20, rising or descending together with the float 21, coordinating with the two faces 200, 201 of the Hall switch 20 to turn it on or off in case of the magnet 22 moving nearer to the face 200 or the face 201.

The Hall Effect Digital switch 20 is connected as shown in FIGS. 7 and 8, but it is not limited in these two modes, as long as the Hall switch 20 can turn on or off the power of the mist producer.

While the preferred embodiments f the invention have been described above, it will be recognized and understood that various modifications may be made therein, and the appended claims are intended to cover all such modifications that may fall within the spirit and scope of the invention.

What is claimed is:

1. A water level control device for a humidifier comprising a housing, a control electric circuit, a water tank positioned in an upper portion of said housing, a mist producer contained in said water tank, a mist chamber provided in an upper portion of said mist producer for temporarily storing vapor, a water level detector provided in said water tank, said water level detector consisting of a Hall effect switch and a float, said Hall effect switch installed in a groove in an inner wall of said water tank, said float having a center hole for a float rod to fit stably therein and a recess for one north pole magnet and one south pole magnet to fit aligned in said recess, said float moving up and down along with the water level in said water tank, said two magnets respectively interacting with said Hall switch to let said Hall switch to turn on or off so as to keep a correct water level in said water tank.

2. The water level control device for a humidifier as claimed in claim 1, wherein said float has a recess in which a magnet is fitted in, and said magnet has one surface with a south pole and another surface with a north pole to interact with said Hall switch fixed in the inner wall of said water tank so that a water level in said water tank may be kept accurately by means of said Hall switch.
